(19) United States
(12) Patent Application Publication
(10) Pub. No.: US 2018/0091504 A1
(43) Pub. Date: Mar. 29, 2018

(54) SYSTEM AND METHOD FOR PROTECTING DATA ITEMS

(71) Applicant: ADI SAGI, RISHON LEZION (IL)

(72) Inventor: ADI SAGI, RISHON LEZION (IL)

(21) Appl. No.: 15/279,464

(22) Filed: Sep. 29, 2016

(51) Int. Cl. H04L 29/06; G06F 21/32; G06F 21/60; G06F 21/62

(52) U.S. Cl. CPC H04L 63/0861; G06F 21/6218; G06F 21/602; G06F 21/32

(57) ABSTRACT

In accordance with a first aspect of the presently disclosed subject matter, there is provided a data access control server comprising: a data access control memory; and a controller; the controller configured to: receive, from an end point device, a data item access request, requesting access to a data item on a data items server; check, if a code that issued the data item access request adheres to a code profile, if a user that issued the data item access request adheres to a user profile, if users devices that are associated in a configuration file with the data item adhere to a user device profile and if the data item is marked in the configuration file as a valuable asset; verify, that access to the data item is allowed through user interface components of the users devices or through biometric verification components of the users devices, if the code does not adhere to the code profile or if the user does not adhere to the user profile or if the users devices do not adhere to the user device profile or if the data item is marked in the configuration file as a valuable asset; and allow, the end point device to access the data item on the data items server, if verification succeeded or if verification was not needed.

### TECHNICAL FIELD

The invention relates to a system and method for protecting data items. More specifically, the present invention relates to a system and method for allowing access to a data item based on proactively building and updating profiles of code, users and users devices and allowing an end point to access a requested data item based on the profile of the code that requested the access, the profile of the user that requested the access and the profile of users devices associated with the data item. When the access request does not adhere to these profiles, verification is achieved utilizing the user interface and biometric verification of the users devices associated with the data item.

### BACKGROUND

Cyber-attacks on individuals, businesses, corporations and even governments have become a major risk for every modern organization. Current protection solutions depends either on access control that relies on permissions and encryption of the data or on data loss prevention mechanisms that relies of data meta-tagging. The disadvantages of these known solutions are that permissions can be breached and that meta-tagging is a complex and a resource consuming process. Known solutions are especially prone to insider attacks—where the attacker is already equipped with the needed authorizations and knows which data to access. There is thus a need in the art for a new method and system for protecting data items.

### SUMMARY

In accordance with a first aspect of the presently disclosed subject matter, there is provided a data access control server comprising: a data access control memory; and a controller; the controller configured to: receive, from an end point device, a data item access request, requesting access to a data item on a data items server; check, if a code that issued the data item access request adheres to a code profile, if a user that issued the data item access request adheres to a user profile, if users devices that are associated in a configuration file with the data item adhere to a user device profile and if the data item is marked in the configuration file as a valuable asset; verify, that access to the data item is allowed through user interface components of the users devices or through biometric verification components of the users devices, if the code does not adhere to the code profile or if the user does not adhere to the user profile or if the users devices do not adhere to the user device profile or if the data item is marked in the configuration file as a valuable asset; and allow, the end point device to access the data item on the data items server, if verification succeeded or if verification was not needed.

In some cases, the controller is further configured to: request, a code information request from the end point device, a user information request from the end point device and user device information request from the users devices; receive, a code information reply from the end point device, a user information reply from the end point device and user device information replies from the users devices; and update, the code profile according to the code information reply, the user profile according to the user information reply and the user device profile according to the users devices information replies.

In some cases, the code information reply includes one or more of the following:
a. executed code information, for each process running on the end point device controller;
b. DLL code information, for each process running on the end point device controller;
c. injected code information, for each process running on the end point device controller;
d. encryption information, for each process running on the end point device controller;
e. parent process information, for each process running on the end point device controller;
f. registry access information, for each process running on the end point device controller;
g. files access information, for each process running on the end point device controller; or
h. list of associated files, for each process running on the end point device controller.

In some cases, the user information reply includes one or more of the following:
a. end point feature information, for each user registered on the end point device controller;
b. application information, for each user registered on the end point device controller;
c. read/write information, for each user registered on the end point device controller;
d. I/O information for keyboard, mouse and touch, for each user registered on the end point device controller;
e. networks information, for each user registered on the end point device controller;
f. identification information, for each user registered on the end point device controller;
g. directory information, for each user registered on the end point device controller; or
h. authorization information, for each user registered on the end point device controller.

In some cases, the user device information reply includes one or more of the following:
a. user device feature information, for each user registered on the user device;
b. application information, for each user registered on the user device;
c. geographic location information, for each user registered on the user device;
d. I/O information for keyboard, mouse and touch, for each user registered on the user device;
e. networks information, for each user registered on the user device;
f. identification information, for each user registered on the user device;
g. directory information, for each user registered on the user device; or
h. authorization information, for each user registered on the user device.

In some cases, the controller is further configured to: receive a configuration file update request; and update the configuration file according to the configuration file update request.

In some cases, the configuration file update request includes one or more of the following:
a. a user device information to be associated with a specific data item; or
b. mark as a valuable asset information to be associated with a specific data item.

In some cases, the controller is further configured to: send reports to a security information and event management server.

In some cases, the data items server is a file server and the data item is a file stored on the file server.

In some cases, the data items server is a private cloud and the data item is a data item stored in the private cloud.

In some cases, the data items server is a public cloud and the data item is a data item stored in the public cloud.

In some cases, the data items server is a data base and the data item is a data base record stored in the data base.

In accordance with a second aspect of the presently disclosed subject matter, there is provided a user device comprising: a user interface component; a biometric verification component; and a processing unit; the processing unit configured to: receive, a data item access verification request from a data access control server; verify, utilizing the user interface component and the biometric verification component that a user of the user device is authorized to access a data item; and send, a data item access verification result to the data access control server.

In some cases, the processing unit is further configured to: receive, a user device information request from the data access control server; and send, a user device information reply to the data access control server.

In some cases, the user device information reply includes one or more of the following:
a. user device feature information, for each user registered on the user device;
b. application information, for each user registered on the user device;
c. geographic location information, for each user registered on the user device;
d. I/O information for keyboard, mouse and touch, for each user registered on the user device;
e. networks information, for each user registered on the user device;
f. identification information, for each user registered on the user device;
g. directory information, for each user registered on the user device; or
h. authorization information, for each user registered on the user device.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of an environment for protecting data items, in accordance with the presently disclosed subject matter;

FIG. 2 is a block diagram schematically illustrating one example of an end point device and a data access control server and a connection therebetween, in accordance with the presently disclosed subject matter;

FIG. 3 is a block diagram schematically illustrating one example of the data access control server and a user device and an authorized user device and a connections therebetween, in accordance with the presently disclosed subject matter;

FIG. 4 is a flowchart illustrating one example of a sequence of operations carried out in the environment for determining if access to a data item is allowed, in accordance with the presently disclosed subject matter;

FIG. 5 is a flowchart illustrating one example of a sequence of operations carried out by the data access control server for building and updating a code profile, a user profile and a user device profile, in accordance with the presently disclosed subject matter;

FIG. 6 is a flowchart illustrating one example of a sequence of operations carried out by the data access control server for updating a configuration file, in accordance with the presently disclosed subject matter; and

FIG. 7 is a flowchart illustrating one example of a sequence of operations carried out by the user device or by the authorized user device for verifying access to a data item is authorized by a user of the user device or by a user of the authorized user device.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

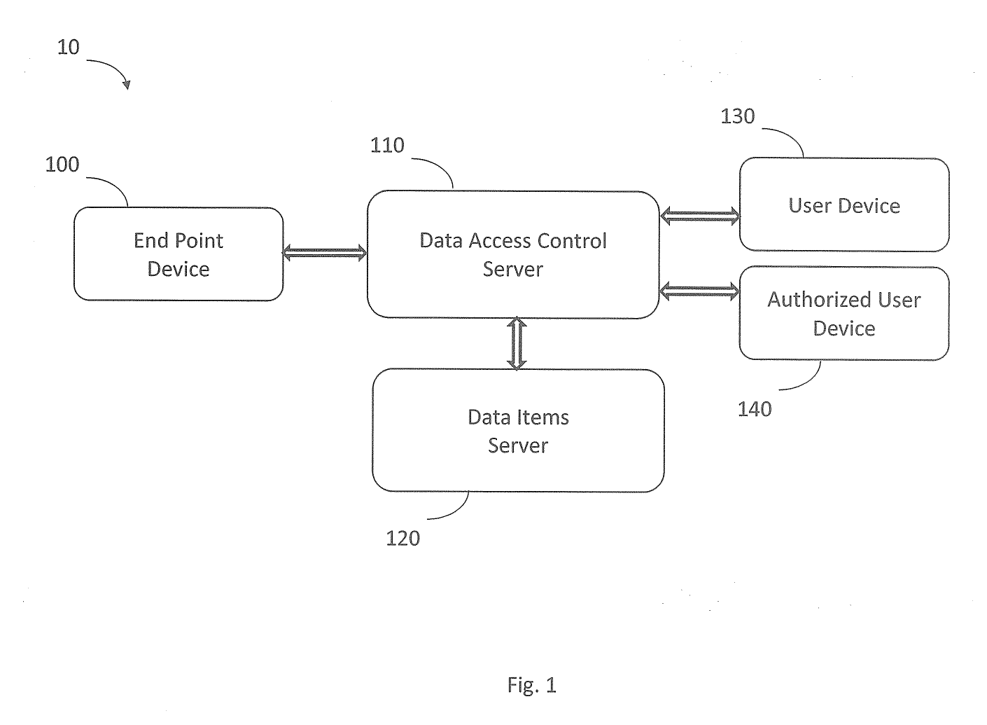

Referring now to FIG. 1, showing a schematic illustration of an environment for protecting data items, in accordance with the presently disclosed subject matter.

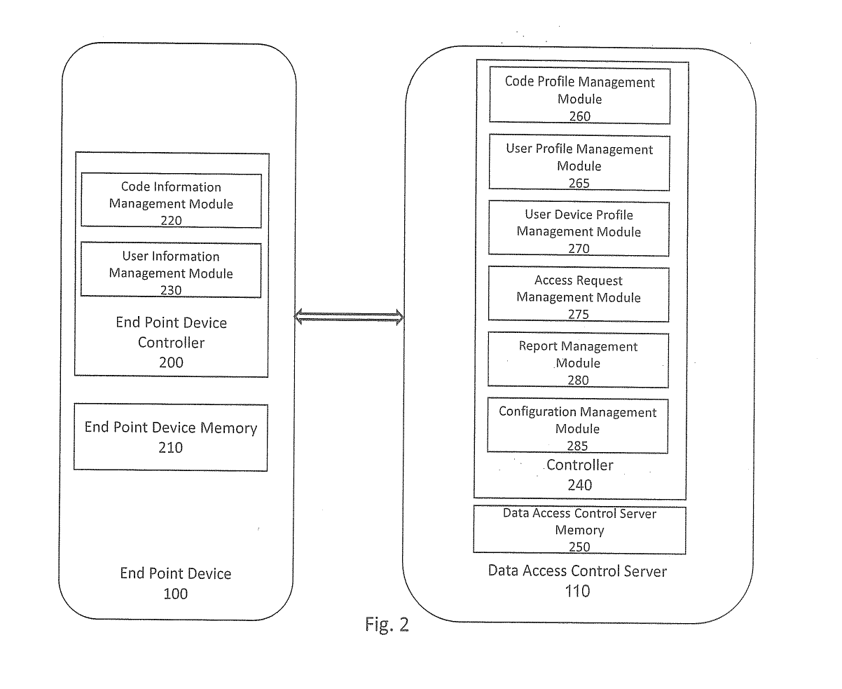

According to certain examples of the presently disclosed subject matter, the environment 10 includes one or more data access control servers 110, each having a controller and data access control server memory, capable of determining if access to a data item is allowed and capable of building and updating a code profile, a user profile and a user device profile, as further detailed herein, inter alia with reference to FIG. 2.

The environment 10 further includes at least one end point device 100 (e.g. a workstation, a laptop, a tablet or any other device capable of running software processes that require access to data items), each having an end point device controller and an end point device memory, capable of requesting access to a data item from the data access control server and capable of receiving a code information request and a user information request from the data access control server 110 and to send in reply a code information reply and a user information reply to the data access control server 110, as further detailed herein, inter alia with reference to FIG. 2.

The environment 10 further includes one or more data items servers 120 (e.g. a file server, a private cloud, a public cloud, a data base or any other data item repository), capable of storing and retrieving data items (e.g. files, data items stored on private or public clouds, data base records or any other data items).

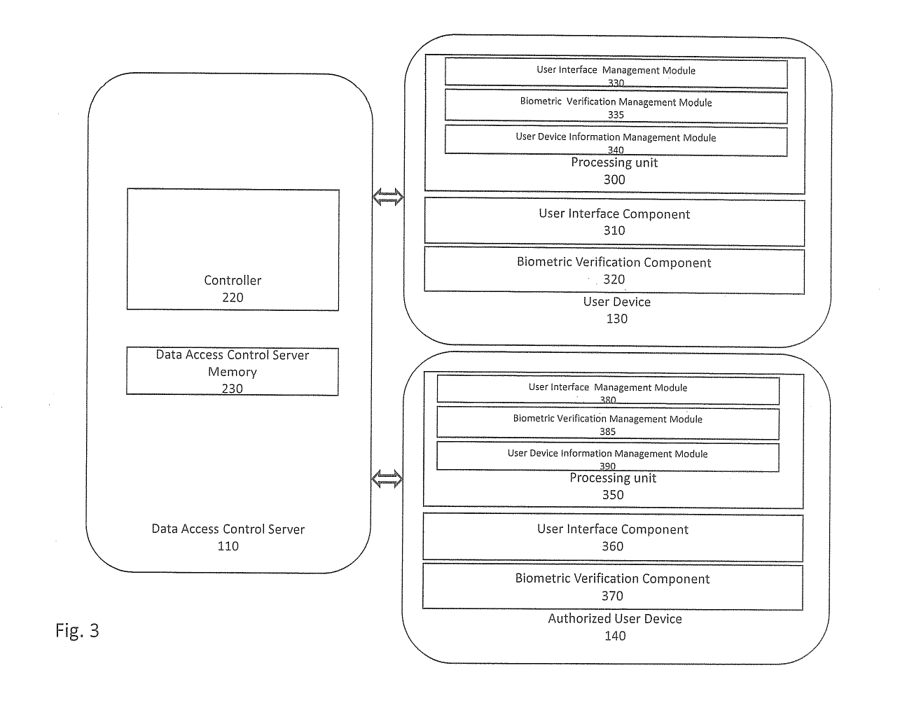

The environment 10 may further include one or more user devices 130 and authorized user devices 140 (e.g. a smartphone, a smartwatch, an IOT device or any other device used by a user or an authorized user), each having a user interface component (e.g. a screen capable of showing a notification or a confirmation window, etc.), capable of notifying the user or the authorized user and receive confirmation from them, a biometric verification component, capable of obtaining biometric information from the user or from the authorized user (e.g. fingerprints, hand geometry, earlobe geometry, retina and iris patterns, voice waves, DNA, signatures, or any other biometric information) and to verify that the biometric information matches the biometric information of that user, and a processing unit, capable of verifying that access to the data item is allowed through the user interface component or through the biometric verification component, the authorized user device 140 is used for authorized users capable of authoring access to the data item in cases that the authorization given by the user of the user device 130 is not sufficient (e.g. when requesting access to a data item that is a valuable asset, or in similar cases) and capable of receiving a user device information request from the data access control server 110 and to send in reply a user device information reply to the data access control server 110, as further detailed herein, inter alia with reference to FIG. 3.

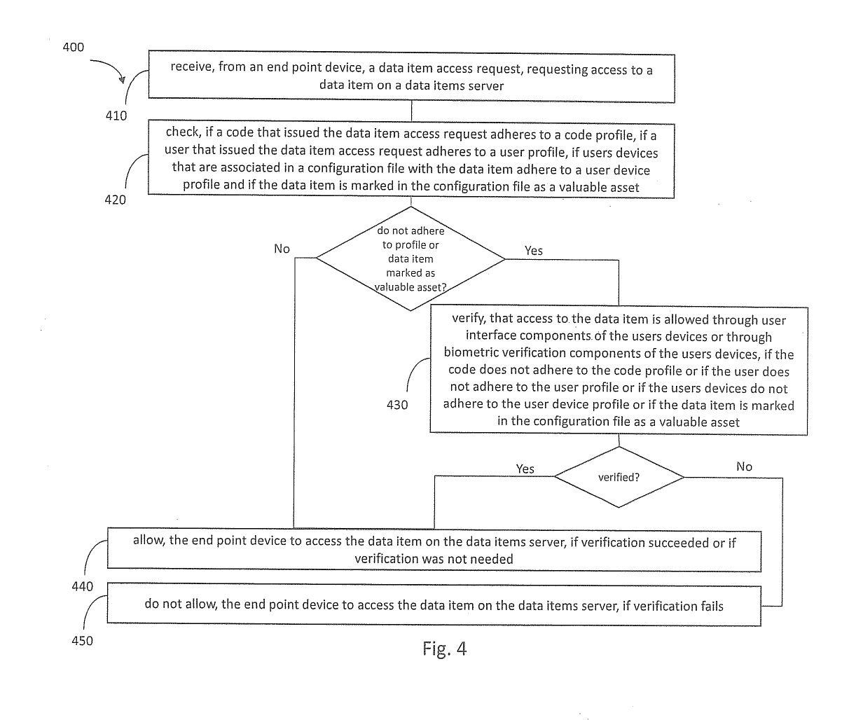

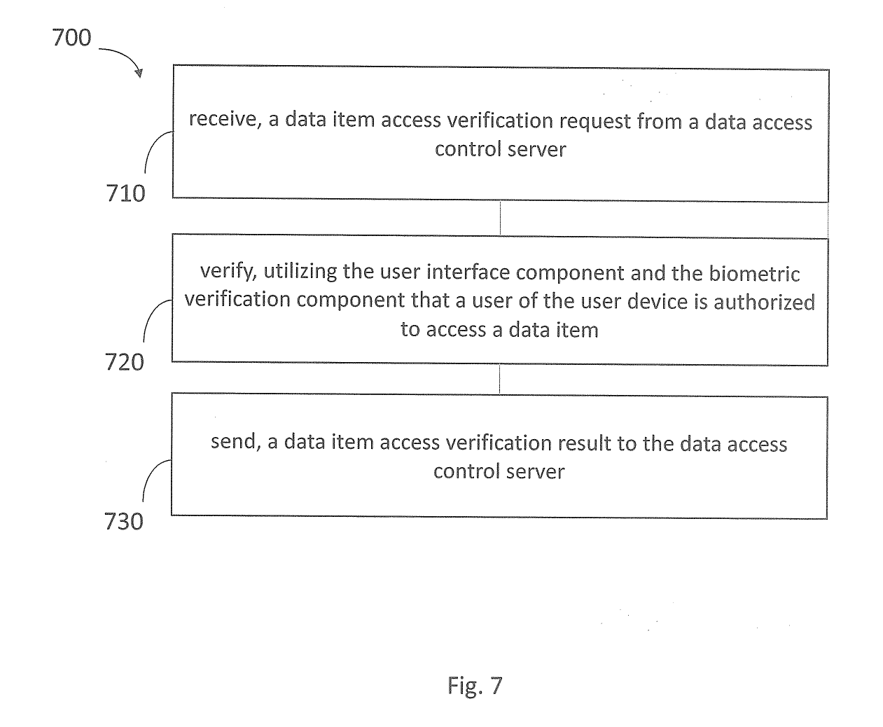

In some cases the end point device 100, initiates a request to access a data item, the data access control server 110 receives the data item access request and checks, if a code that issued the data item access request adheres to a code profile, if a user that issued the data item access request adheres to a user profile, if users devices that are associated in a configuration file with the data item adhere to a user device profile and if the data item is marked in the configuration file as a valuable asset, if the code does not adhere to the code profile or if the user does not adhere to the user profile or if the users devices do not adhere to the user device profile or if the data item is marked as a valuable asset, then the data access control server 110 verifies, that access to the data item is allowed through the user interface component of the user device 130 or of the authorized user device 140, or through biometric verification components of the user device 130 or the authorized user device 140, if verification succeeds, then the end point device 100 is allowed to access the data item on the data items server 120, as further detailed herein, inter alia with reference to FIGS. 4, 7.

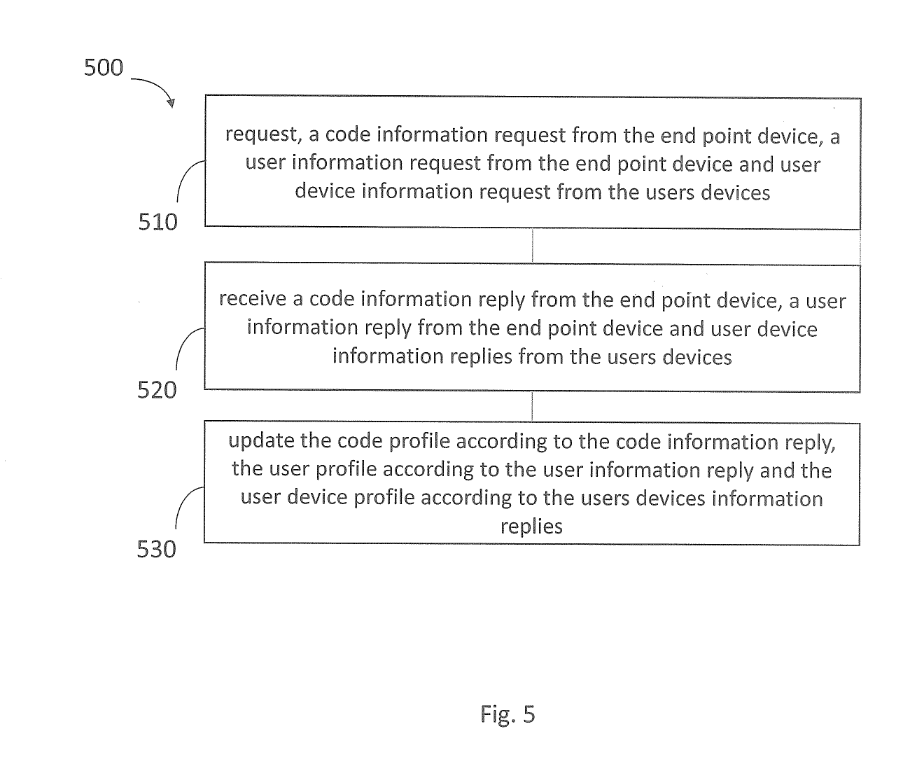

In some cases the data access control server 110, builds and updates the code profile, the user profile and the user device profile, by requesting, a code information request from the end point device 110, a user information request from the end point device 110 and user device information request from the user device 130 and from the authorized user device 140, receiving a code information reply from the end point device 110, a user information reply from the end point device 110 and a user device information reply from the user device 130 and from the authorized user device 140 and updating the code profile according to the code information reply, the user profile according to the user information reply and the user device profile according to the users devices information replies, as further detailed herein, inter alia with reference to FIG. 5.

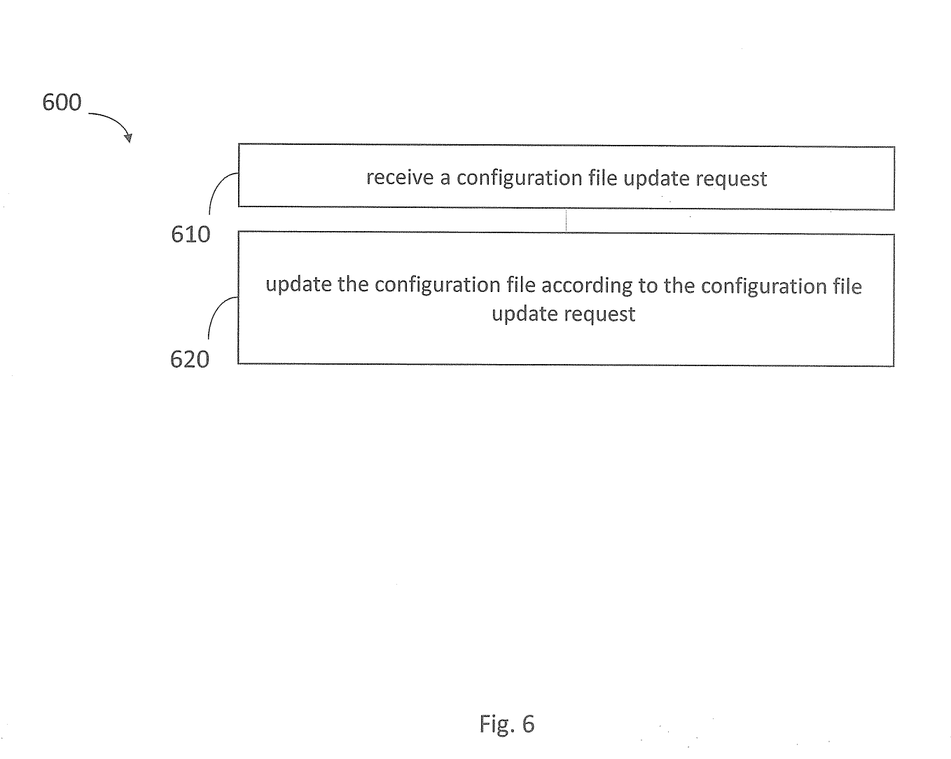

In some cases the data access control server 110, receives a configuration file update request (e.g. a user device information to be associated with a specific data item, a mark as a valuable asset information to be associated with a specific data item, or other configuration information) from a user of the data access control server 110 and updates the configuration file according to the configuration file update request, as further detailed herein, inter alia with reference to FIG. 6.

Attention is now drawn to FIG. 2, showing a block diagram schematically illustrating one example of an end point device and a data access control server and a connection therebetween, in accordance with the presently disclosed subject matter.

The data access control server 110 can comprise or be otherwise associated with a data access control server memory 250 (e.g. a database, a storage system, a memory including Read Only Memory—ROM, Random Access Memory—RAM, or any other type of memory, etc.) configured to store data, including, inter alia, a configuration file, etc., as further detailed herein. In some cases, the data access control server memory 250 can be further configured to enable retrieval and/or update and/or deletion of the stored data. It is to be noted that in some cases, the data access control server memory 250 can be distributed.

The data access control server 110 further includes a controller 240. The controller 240 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant data access control server 110 resources and for enabling operations related to data access control server 110 resources.

The controller 240 can comprise one or more of the following modules: a code profile management module 260, a user profile management module 265, a user device profile management module 270, an access request management module 275, a report management module 280 and a configuration management module 285.

According to some examples of the presently disclosed subject matter, the code profile management module 260 can be configured to retrieve the code profile for a specific code that initiated a data item access request and to update the code profile according to the code information reply received from the end point device 110, as further detailed, inter alia, with reference to FIGS. 4, 5.

The user profile management module 265 can be configured to retrieve the user profile for a specific user that initiated the data item access request and to update the user profile according to the user information reply received from the end point device 110, as further detailed, inter alia, with reference to FIGS. 4, 5.

The user device profile management module 270 can be configured to retrieve the user device profile for a specific user device that is associated in the configuration file with a data item and to update the user device profile according to the user device information reply received from the user device 130 and from the authorized user device 140, as further detailed, inter alia, with reference to FIGS. 4, 5.

The configuration management module 285 can be configured to retrieve and to update information in the configuration file, including: a user device information to be associated with a specific data item or a mark as a valuable asset information to be associated with a specific data item, as further detailed, inter alia, with reference to FIG. 6.

The access request management module 275 can be configured to receive the data item access request and to check, utilizing the code profile management module 260, the user profile management module 265, the user device profile management module 270 and the configuration management module 285 accordingly, if the code that issued the data item access request adheres to the code profile, if the user that issued the data item access request adheres to the user profile, if users devices that are associated in the configuration file with the data item adhere to the user device profile and if the data item is marked in the configuration file as a valuable asset, if the code does not adhere to the code profile or if the user does not adhere to the user profile or if the users devices do not adhere to the user device profile or if the data item is marked as a valuable asset, then the access request management module 275 is configured to verify that access to the data item is allowed through the user interface component of the user device 130 or of the authorized user device 140, or through biometric verification components of the user device 130 or the authorized user device 140, if verification succeeds, then the end point device 100 is allowed to access the data item on the data items server 120, as further detailed, inter alia, with reference to FIGS. 4, 7.

The report management module 280 is configured to prepare and send reports to a security information and event management server.

As indicated herein, in some cases the data access control server 110 can receive the data item access request from the end point device 100. The end point device 100 can comprise or be otherwise associated with an end point device memory 210 (e.g. a database, a storage system, a memory including Read Only Memory—ROM, Random Access Memory—RAM, or any other type of memory, etc.) configured to store data, including, inter alia, a configuration file, etc., as further detailed herein. In some cases, the end point device memory 210 can be further configured to enable retrieval and/or update and/or deletion of the stored data. It is to be noted that in some cases, the end point device memory 210 can be distributed.

The end point device 100 further includes an end point device controller 200. The end point device controller 200 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant end point device 100 resources and for enabling operations related to end point device 100 resources.

The end point device controller 200 can comprise one or more of the following modules: a code information management module 220 and a user information management module 230.

According to some examples of the presently disclosed subject matter, the code information management module 220 can be configured to receive a code information request from the data access control server 110 and send a code information reply (e.g. executed code information, for each process running on the end point device controller 200, DLL code information, for each process running on the end point device controller 200, injected code information, for each process running on the end point device controller 200, encryption information, for each process running on the end point device controller 200, parent process information, for each process running on the end point device controller 200, registry access information, for each process running on the end point device controller 200, files access information, for each process running on the end point device controller 200, list of associated files, for each process running on the end point device controller 200, or any other code information) to the data access control server 110, as further detailed, inter alia, with reference to FIG. 5.

The user information management module 230 can be configured to receive a user information request from the data access control server 110 and send a code information reply (e.g. end point feature information, for each user registered on the end point device controller 200, application information, for each user registered on the end point device controller 200, read/write information, for each user registered on the end point device controller 200, I/O information for keyboard, mouse and touch, for each user registered on the end point device controller 200, networks information, for each user registered on the end point device controller 200, identification information, for each user registered on the end point device controller 200, directory information, for each user registered on the end point device controller 200, authorization information, for each user registered on the end point device controller 200, or any other user information) to the data access control server 110, as further detailed, inter alia, with reference to FIG. 5.

Attention is now drawn to FIG. 3, showing a block diagram schematically illustrating one example of the data access control server 110 and a user device 130 and an authorized user device 140 and the connections therebetween, in accordance with the presently disclosed subject matter.

The user device 130 can comprise or be otherwise associated with a processing unit 300. The processing unit 300 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant user device 130 resources and for enabling operations related to user device 130 resources.

The user device 130 further includes a user interface component 310 (e.g. a screen capable of showing a notification or a confirmation window, etc.), capable of notifying the user of the user device 130 and to receive confirmation from him, and a biometric verification component 320, capable of obtaining biometric information from the user of the user device 130 (e.g. fingerprints, hand geometry, earlobe geometry, retina and iris patterns, voice waves, DNA, signatures, or any other biometric information) and to verify that the biometric information matches the biometric information of that user.

The processing unit 300 can comprise one or more of the following modules: a user interface management module 330, a biometric verification management module 335 and a user device information management module 340.

According to some examples of the presently disclosed subject matter, the user interface management module 330 can be configured to notify the user of the user device 130 and receive confirmation from him, as further detailed, inter alia, with reference to FIGS. 4, 7.

The biometric verification management module 335 can be configured to obtain biometric information from the user of the user device 130 and to verify that the biometric information matches the biometric information of that user, as further detailed, inter alia, with reference to FIGS. 4, 7.

The user device information management module 340 can be configured to receive a user device information request from the data access control server 110 and send a user device information reply (e.g. user device feature information, for each user registered on the user device 130, application information, for each user registered on the user device 130, geographic location information, for each user registered on the user device 130, I/O information for keyboard, mouse and touch, for each user registered on the user device 130, networks information, for each user registered on the user device 130, identification information, for each user registered on the user device 130, directory information, for each user registered on the user device 130, authorization information, for each user registered on the user device 130 or any other user device information) to the data access control server 110, as further detailed, inter alia, with reference to FIG. 5.

The authorized user device 140 can comprise or be otherwise associated with a processing unit 350. The processing unit 350 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant authorized user device 140 resources and for enabling operations related to user device 130 resources.

The authorized user device 140 further includes a user interface component 360 (e.g. a screen capable of showing a notification or a confirmation window, etc.), capable of notifying the user of the authorized user device 140 and to receive confirmation from him, and a biometric verification component 320, capable of obtaining biometric information from the user of the authorized user device 140 (e.g. fingerprints, hand geometry, earlobe geometry, retina and iris patterns, voice waves, DNA, signatures, or any other biometric information) and to verify that the biometric information matches the biometric information of that user.

The processing unit 350 can comprise one or more of the following modules: a user interface management module 380, a biometric verification management module 385 and a user device information management module 390.

According to some examples of the presently disclosed subject matter, the user interface management module 380 can be configured to notify the user of the authorized user device 140 and receive confirmation from him, as further detailed, inter alia, with reference to FIGS. 4, 7.

The biometric verification management module 385 can be configured to obtain biometric information from the user of the authorized user device 140 and to verify that the biometric information matches the biometric information of that user, as further detailed, inter alia, with reference to FIGS. 4, 7.

The user device information management module 390 can be configured to receive a user device information request from the data access control server 110 and send a user device information reply (e.g. user device feature information, for each user registered on the authorized user device 140, application information, for each user registered on the authorized user device 140, geographic location information, for each user registered on the authorized user device 140, I/O information for keyboard, mouse and touch, for each user registered on the authorized user device 140, networks information, for each user registered on the authorized user device 140, identification information, for each user registered on the authorized user device 140, directory information, for each user registered on the authorized user device 140, authorization information, for each user registered on the authorized user device 140 or any other user device information) to the data access control server 110, as further detailed, inter alia, with reference to FIG. 5.

In some cases the authorized user device 140 is used for authorized users capable of authoring access to the data item in cases that the authorization given by the user of the user device 130 is not sufficient (e.g. when requesting access to a data item that is a valuable asset, or in similar cases), as further detailed, inter alia, with reference to FIGS. 4, 7.

Having described the environment 10 and the components thereof, attention is drawn to FIG. 4, showing a flowchart illustrating one example of a sequence of operations carried out in the environment 10 for determining if access to a data item is allowed, in accordance with the presently disclosed subject matter.

According to some examples of the presently disclosed subject matter, the data access control server 110 can be configured to execute a data item access determination process 400, utilizing the access request management module 275.

As indicated herein, in some cases the end point device 100, initiates a request to access a data item on a data item server 120, the data access control server 110 receives the data item access request (block 410).

After receiving the data item access request, from the end point device 100, the data access control server then checks, utilizing an access request management module 275 if a code that issued the data item access request adheres to a code profile, utilizing a code profile management module 260 and checks if a user that issued the data item access request adheres to a user profile, utilizing a user profile management module 265 and checks if users devices that are associated in a configuration file with the data item adhere to a user device profile, utilizing a user profile management module 270 and a configuration management module 285 and checks if the data item is marked in the configuration file as a valuable asset, utilizing the configuration management module 285 (block 420).

In case that the code does not adhere to the code profile or if the user does not adhere to the user profile or if the users devices do not adhere to the user device profile or if the data item is marked as a valuable asset, then the data access control server 110 verifies, that access to the data item is allowed through a user interface component 310 of the user device 130 or through a user interface component 360 of the authorized user device 140, or through biometric verification component 320 of the user device 130 or through biometric verification component 370 of the authorized user device 140, depending on the user devices associated with data item in the configuration file (block 430).

In cases that verification described herein in block 430 succeeds and in cases that verification was not required, because the code adheres to the code profile and the user adheres to the user profile and the users devices adhere to the user device profile and the data item is not marked as a valuable asset, then the end point device 100 is allowed to access the data item on the data items server 120 (block 440).

In cases that verification described herein in block 430 fails, then the end point device 100 is not allowed to access the data item on the data items server 120 (block 450).

It is to be noted that, with reference to FIG. 4, that some of the blocks can be integrated into a consolidated block or can be broken down to a few blocks and/or other blocks may be added. It should be also noted that whilst the flow diagram is described also with reference to the environment 10 elements that realizes them, this is by no means binding, and the blocks can be performed by elements other than those described herein.

Turning to FIG. 5, there is shown a flowchart illustrating one example of a sequence of operations carried out by a data access control server 110 for building and updating a code profile, a user profile and a user device profile, in accordance with the presently disclosed subject matter.

According to some examples of the presently disclosed subject matter, the data access control server 110 can be configured to execute a profiles building and updating process 500, utilizing a code profile management module 260, a user profile management module 265 and a user device profile management module 270.

As indicated herein, in some cases the data access control server 110, builds and updates the code profile, the user profile and the user device profile, by requesting a code information request, utilizing a code profile management module 260, from the end point device 110 and by requesting a user information request, utilizing a user profile management module 265, from the end point device 110 and by requesting a user device information request, utilizing a user device profile management module 270, from the user device 130 and from the authorized user device 140 (block 510).

The data access control server 110 then receives a code information reply from the end point device 110, a user information reply from the end point device 110 and a user device information reply from the user device 130 and from the authorized user device 140 (block 520).

The data access control server 110 then updates the code profile according to the code information reply, the user profile according to the user information reply and the user device profile according to the users devices information replies (block 530).

It is to be noted that, with reference to FIG. 5, that some of the blocks can be integrated into a consolidated block or can be broken down to a few blocks and/or other blocks may be added. It should be also noted that whilst the flow diagram is described also with reference to the environment 10 elements that realizes them, this is by no means binding, and the blocks can be performed by elements other than those described herein.

Turning to FIG. 6, there is shown a flowchart illustrating one example of a sequence of operations carried out by the data access control server for updating a configuration file, in accordance with the presently disclosed subject matter.

According to some examples of the presently disclosed subject matter, the data access control server 110 can be configured to execute a configuration file updating process 600, utilizing a configuration management module 285.

As indicated herein, in some cases the data access control server 110, receives a configuration file update request (e.g. a user device information to be associated with a specific data item, a mark as a valuable asset information to be associated with a specific data item, or other configuration information) from a user of the data access control server 110 (block 610).

The data access control server 110 then updates the configuration file according to the configuration file update request (block 620).

It is to be noted that, with reference to FIG. 6, that some of the blocks can be integrated into a consolidated block or can be broken down to a few blocks and/or other blocks may be added. It should be also noted that whilst the flow diagram is described also with reference to the environment 10 elements that realizes them, this is by no means binding, and the blocks can be performed by elements other than those described herein.

Turning to FIG. 7, there is shown a flowchart illustrating one example of a sequence of operations carried out by the user device 130 or by the authorized user device 140 for verifying access to a data item is authorized by a user of the user device 130 or by a user of the authorized user device 140.

According to some examples of the presently disclosed subject matter, the user device 130 and the authorized user device 140 can be configured to execute a data item verification process 700, utilizing a user interface management module 330 and a biometric verification management module 335 of the user device 130 and utilizing a user interface management module 380 and a biometric verification management module 395 of the authorized user device 140.

As indicated herein, in some cases the user device 130 or the authorized user device 140 can be configured to receive a data item access verification request from the data access control server (block 710). The received data item access verification request is the data item access verification request sent at block 430.

The user device 130, utilizing a user interface component 310 and 1 biometric verification component 320 or the authorized user device 140 utilizing the user interface component 360 and the biometric verification component 370 then verifies that a user of the user device 130 or a user of the authorized user device 140 is authorized to access a data item (block 720).

The user device 130 or the authorized user device 140 then send a data item access verification result to the data access control server (block 730). The sent data item access verification result is the data item access verification result sent at block 430.

It is to be noted that, with reference to FIG. 7, that some of the blocks can be integrated into a consolidated block or can be broken down to a few blocks and/or other blocks may be added. It should be also noted that whilst the flow diagram is described also with reference to the environment 10 elements that realizes them, this is by no means binding, and the blocks can be performed by elements other than those described herein.

Unless specifically stated otherwise, as apparent from the following discussions, it is appreciated that throughout the specification discussions utilizing terms such as “receiving”, “requesting”, “checking”, “verifying”, “allowing”, “updating” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), any other electronic computing device, and/or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter, fewer, more and/or different stages than those shown in FIG. 4-7 may be executed. In embodiments of the presently disclosed subject matter one or more stages illustrated in FIG. 4-7 may be executed in a different order and/or one or more groups of stages may be executed simultaneously. FIGS. 1-3 illustrate a general schematic of the system architecture in accordance with an embodiment of the presently disclosed subject matter. Each module in FIGS. 1-3 can be made up of any combination of software, hardware and/or firmware that performs the functions as defined and explained herein. The modules in FIGS. 1-3 may be centralized in one location or dispersed over more than one location. In other embodiments of the presently disclosed subject matter, the system may comprise fewer, more, and/or different modules than those shown in FIGS. 1-3.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A data access control server comprising:
a data access control memory; and
a controller;
said controller configured to:
receive, from an end point device, a data item access request, requesting access to a data item on a data items server;
check, if a code that issued said data item access request adheres to a code profile, if a user that issued said data item access request adheres to a user profile, if users devices that are associated in a configuration file with said data item adhere to a user device profile and if said data item is marked in said configuration file as a valuable asset;
verify, that access to said data item is allowed through user interface components of said users devices or through biometric verification components of the users devices, if said code does not adhere to said code profile or if said user does not adhere to said user profile or if said users devices do not adhere to said user device profile or if said data item is marked in said configuration file as a valuable asset; and
allow, said end point device to access said data item on said data items server, if verification succeeded or if verification was not needed.

2. The server of claim 1, wherein the controller is further configured to:
request, a code information request from said end point device, a user information request from said end point device and user device information request from said users devices;
receive, a code information reply from said end point device, a user information reply from said end point device and user device information replies from said users devices; and
update, said code profile according to said code information reply, said user profile according to said user information reply and said user device profile according to said users devices information replies.

3. Said server of claim 2, wherein said code information reply includes one or more of said following:
a. executed code information, for each process running on said end point device controller;
b. DLL code information, for each process running on said end point device controller;
c. injected code information, for each process running on said end point device controller;
d. encryption information, for each process running on said end point device controller;
e. parent process information, for each process running on said end point device controller;
f. registry access information, for each process running on said end point device controller;
g. files access information, for each process running on said end point device controller; or
h. list of associated files, for each process running on said end point device controller.

4. The server of claim 2, wherein said user information reply includes one or more of said following:
a. end point feature information, for each user registered on said end point device controller;
b. application information, for each user registered on said end point device controller;
c. read/write information, for each user registered on said end point device controller;
d. I/O information for keyboard, mouse and touch, for each user registered on said end point device controller;
e. networks information, for each user registered on said end point device controller;
f. identification information, for each user registered on said end point device controller;
g. directory information, for each user registered on said end point device controller; or
h. authorization information, for each user registered on said end point device controller.

5. The server of claim 2, wherein said user device information reply includes one or more of said following:
a. user device feature information, for each user registered on said user device;
b. application information, for each user registered on said user device;
c. geographic location information, for each user registered on said user device;
d. I/O information for keyboard, mouse and touch, for each user registered on said user device;
e. networks information, for each user registered on said user device;
f. identification information, for each user registered on said user device;
g. directory information, for each user registered on said user device; or
h. authorization information, for each user registered on said user device.

6. The server of claim 1, wherein the controller is further configured to:
receive a configuration file update request; and
update the configuration file according to the configuration file update request.

7. The server of claim 6, wherein the configuration file update request includes one or more of the following:
a. a user device information to be associated with a specific data item; or
b. mark as a valuable asset information to be associated with a specific data item.

8. The server of claim 1, wherein the controller is further configured to send reports to a security information and event management server.

9. The server of claim 1, wherein the data items server is a file server and the data item is a file stored on the file server.

10. The server of claim 1, wherein the data items server is a private cloud and the data item is a data item stored in the private cloud.

11. The server of claim 1, wherein the data items server is a public cloud and the data item is a data item stored in the public cloud.

12. The server of claim 1, wherein the data items server is a data base and the data item is a data base record stored in the data base.

13. A user device comprising:
a user interface component;
a biometric verification component; and
a processing unit;
the processing unit configured to:
receive, a data item access verification request from a data access control server;
verify, utilizing the user interface component and the biometric verification component that a user of the user device is authorized to access a data item; and
send, a data item access verification result to the data access control server.

14. The device of claim 13, wherein the processing unit is further configured to:
receive, a user device information request from the data access control server; and
send, a user device information reply to the data access control server.

15. The device of claim 14, wherein the user device information reply includes one or more of the following:
a. user device feature information, for each user registered on the user device;
b. application information, for each user registered on the user device;
c. geographic location information, for each user registered on the user device;
d. I/O information for keyboard, mouse and touch, for each user registered on the user device;
e. networks information, for each user registered on the user device;
f. identification information, for each user registered on the user device;
g. directory information, for each user registered on the user device; or authorization information, for each user registered on the user device.

16. A method comprising:
receiving, by a controller comprised within a data access control server, from an end point device, a data item access request, requesting access to a data item on a data items server;
checking, by the controller, if a code that issued the data item access request adheres to a code profile, if a user that issued the data item access request adheres to a user profile, if users devices that are associated in a configuration file with the data item adhere to a user device profile and if the data item is marked in the configuration file as a valuable asset;
verifying, by the controller, that access to the data item is allowed through user interface components of the users devices or through biometric verification components of the users devices, if the code does not adhere to the code profile or if the user does not adhere to the user profile or if the users devices do not adhere to the user device profile or if the data item is marked in the configuration file as a valuable asset; and
allowing, by the controller, the end point device to access the data item on the data items server, if verification succeeded or if verification was not needed.

17. The method of claim 16, further comprising requesting, by the controller, a code information request from the end point device, a user information request from the end point device and user device information request from the users devices; receiving, by the controller, a code information reply from the end point device, a user information reply from the end point device and user device information replies from the users devices; and updating, by the controller, the code profile according to the code information reply, the user profile according to the user information reply and the user device profile according to the users devices information replies.

18. The method of claim 17, wherein the code information reply includes one or more of the following:
a. executed code information, for each process running on the end point device controller;
b. DLL code information, for each process running on the end point device controller;
c. injected code information, for each process running on the end point device controller;
d. encryption information, for each process running on the end point device controller;
e. parent process information, for each process running on the end point device controller;
f. registry access information, for each process running on the end point device controller;
g. files access information, for each process running on the end point device controller; or
h. list of associated files, for each process running on the end point device controller.

19. The method of claim 17, wherein the user information reply includes one or more of the following:
a. end point feature information, for each user registered on the end point device controller;
b. application information, for each user registered on the end point device controller;
c. read/write information, for each user registered on the end point device controller;
d. I/O information for keyboard, mouse and touch, for each user registered on the end point device controller;
e. networks information, for each user registered on the end point device controller;
f. identification information, for each user registered on the end point device controller;
g. directory information, for each user registered on the end point device controller; or
h. authorization information, for each user registered on the end point device controller.

20. The method of claim 17, wherein the user device information reply includes one or more of the following:
a. user device feature information, for each user registered on the user device;
b. application information, for each user registered on the user device;
c. geographic location information, for each user registered on the user device;
d. I/O information for keyboard, mouse and touch, for each user registered on the user device;
e. networks information, for each user registered on the user device;
f. identification information, for each user registered on the user device;
g. directory information, for each user registered on the user device; or
h. authorization information, for each user registered on the user device.

21. The method of claim 16, further comprising receiving, by the controller, a configuration file update request; and updating, by the controller, the configuration file according to the configuration file update request.

22. The method of claim 21, wherein the configuration file update request includes one or more of the following:
a. a user device information to be associated with a specific data item; or
b. mark as a valuable asset information to be associated with a specific data item.

23. The method of claim 16, further comprising sending, by the controller, reports to a security information and event management server.

24. The method of claim 16, wherein the data items server is a file server and the data item is a file stored on the file server.

25. The method of claim 16, wherein the data items server is a private cloud and the data item is a data item stored in the private cloud.

26. The method of claim 16, wherein the data items server is a public cloud and the data item is a data item stored in the public cloud.

27. The method of claim 16, wherein the data items server is a data base and the data item is a data base record stored in the data base.

28. A method comprising:
receiving, by a processing unit comprised within a user device, a data item access verification request from a data access control server;
verifying, by the processing unit, utilizing a user interface component and a biometric verification component that a user of the user device is authorized to access a data item; and
sending, by the processing unit, a data item access verification result to the data access control server.

29. The method of claim 28, further comprising receiving, by the processing unit, a user device information request from the data access control server; and sending, by the processing unit, a user device information reply to the data access control server.

30. The method of claim 29, wherein the user device information reply includes one or more of the following:
a. user device feature information, for each user registered on the user device;
b. application information, for each user registered on the user device;
c. geographic location information, for each user registered on the user device;
d. I/O information for keyboard, mouse and touch, for each user registered on the user device;
e. networks information, for each user registered on the user device;
f. identification information, for each user registered on the user device;
g. directory information, for each user registered on the user device; or
h. authorization information, for each user registered on the user device.

31. A non-transitory computer readable storage medium having computer readable program code embodied therewith, the computer readable program code, executable by at least one processor of a computer to perform a method comprising:
receiving, by a controller comprised within a data access control server, from an end point device, a data item access request, requesting access to a data item on a data items server;
checking, by the controller, if a code that issued the data item access request adheres to a code profile, if a user that issued the data item access request adheres to a user profile, if users devices that are associated in a configuration file with the data item adhere to a user device profile and if the data item is marked in the configuration file as a valuable asset;
verifying, by the controller, that access to the data item is allowed through user interface components of the users devices or through biometric verification components of the users devices, if the code does not adhere to the code profile or if the user does not adhere to the user profile or if the users devices do not adhere to the user device profile or if the data item is marked in the configuration file as a valuable asset; and
allowing, by the controller, the end point device to access the data item on the data items server, if verification succeeded or if verification was not needed.

32. A non-transitory computer readable storage medium having computer readable program code embodied therewith, the computer readable program code, executable by at least one processor of a computer to perform a method comprising:
receiving, by a processing unit comprised within a user device, a data item access verification request from a data access control server;
verifying, by the processing unit, utilizing a user interface component and a biometric verification component that a user of the user device is authorized to access a data item; and
sending, by the processing unit, a data item access verification result to the data access control server.
